(19) United States
(12) Patent Application Publication
(10) Pub. No.: US 2008/0236020 A1
(43) Pub. Date: Oct. 2, 2008

(54) BAIT CAGE

(76) Inventor: Rodney D. Murrell, Batson, TX (US)

Correspondence Address: ARNOLD & KNOBLOCH, L.L.P., 2401 FOUNTAIN VIEW DRIVE, SUITE 630, HOUSTON, TX, 77057, US

(21) Appl. No.: 12/056,307

(22) Filed: Mar. 27, 2008

Related U.S. Application Data
(60) Provisional application No. 60/920,292, filed on Mar. 27, 2007.

(51) Int. Cl. A01K 91/06; A01K 91/04; A01K 93/00

(52) U.S. Cl. 43/4.5; 43/43.1; 43/44.4; 43/43.14

(57) ABSTRACT

A bait cage device and method for sustaining bait during fishing operations is provided. A capsulate shaped structure has an opening for inserting the bait. At least one vent on the capsulate shaped structure provides fluid communication between the exterior and interior of the bait cage. A lid is hingedly disposed on the capsulate shaped structure to cover the opening. At least one anchor point is disposed on the capsulate shaped structure, operable to receive a line. At least one anchor point is disposed on the capsulate shaped structure, operable to receive a hook. The lid further has a clasp, the clasp releasably mated with the capsulate shaped structure to close the opening. The clasp releases the lid into an open position upon application of pressure to radial diametrically opposed sides of the exterior of the capsulate shaped structure.

### STATEMENT OF RELATED CASES

This application claims the benefit of U.S. Provisional Patent Application No. 60/920,292, filed Mar. 27^{th}, 2007.

### FIELD OF THE INVENTION

The present invention relates generally to an apparatus, means and methods to secure bait for fishing. In particular, the bait is rendered less likely to be wasted and is further conserved for repeated use.

### BACKGROUND

Previous attempts to secure and conserve bait have focused on creating a fishing lure with a hollow body to hold the bait. These previous attempts have generally met with complications in their features which make them either hard to use or otherwise too inconvenient for practical application. For instance, it is not desirable to require intricate threading of line or hooks, which provides opportunity for frustration and consumes precious fishing time. It is also difficult to manage threaded screw caps, especially with greasy hands and attached hooks, as typically experienced while fishing.

Spring-loaded caps suffer from a static required opening force. It is desirable to have a large opening-force required during deployment for fishing operations, but a relatively low opening-force required for insertion of the bait. If the required opening-force is too low, the bait may escape. In such case, spring-loaded caps are subject to opening by fish and do not offer sufficient closing-force relative to desired low opening force. On the other hand, if the required opening-force is too high, the device is inconvenient to operate, given typical fishing conditions. It is further desired to have the ability to open the cap without any tools or instruments and, further, to be able to hold and open the device with one hand. In combination with other improvements, the present invention dispenses with spring mechanisms, threaded fittings, and the need for two hands to open.

Waldrip, U.S. Pat. No. 5,036,617 discloses a fishing lure with a hollow body and a closable end cap which can be snapped open or shut or screwed on or off in order to insert live bait or cut bait into the hollow body, a plurality of ventilation slots, hooks, and a latch mechanism used to keep a cap in the closed state. In order to open the cap, a user inserts a thumb nail or a blade into a gap to push the latch inwardly.

Bell, U.S. Pat. No. 2,439,123 discloses a fish lure comprising a hollow tubular transparent body, a snap-fit front cap member, a locking seat or groove, spaced vents, an eye for attaching a fishing line, a pair of spaced eyes, and multiple barbed casting or trolling hooks wherein live bait such as a minnow or frog may be used. A front cap member screws into an internally threaded end of the lure body.

MacDonald, U.S. Pat. No. 4,603,502 discloses a lure structure composed of an elongated configuration defined by a lateral wall of a housing disposed in surrounding relation to an interior chamber, end walls, a housing, and a bait fish wherein the housing, the lateral wall and at least one of the end walls is formed of a flexible transparent and lightweight plastic material including a plurality of integrally formed apertures. An entrance means is provided to define one end such that the entrance means include a plurality of adjacently positioned and separable segments.

Baldwin, U.S. Pat. No. 4,841,664 discloses a fish lure including a tubular container which is integrally constructed of a continuous side wall essentially in a cylindrical shape and having a front curved closure wall, a rear closure plug, a front hole, a rear hole, and additional holes are provided in the side wall, including a first pair of holes, a rear side hole at which point a treble hook is attached, and live bait. A rear closure is a separate molded force fitted closure plug.

Accordingly, Applicant has invented a new and non-obvious bait cage that dispenses with the need for complicated line attachment, provides for a cap that is not subject to opening during deployment but easily opened with one hand (two hands may be used), and may be adapted to specific deployment applications.

### SUMMARY OF THE INVENTION

An example of the present invention includes a device that holds and saves bait, where a hook may be attached to the device, the device designed for attachment to a fishing line. In a further example, vents may be used to allow mixing of water with the bait to distribute smell and allow live bait to breath. In a further example, a reclosable, or “snap” lid allows insertion of bait and prevents bait from exiting the cage. The device may include rings to hold one or more hooks. The device may be sized for swallow, or attempted swallow, by the targeted fish. In a specific example for sight-feeders, such as crappie, the cage is substantially made of clear material, has a rounded end to give the appearance of a head, and has at least one anchor point for the line placed opposite the rings that hold the hooks (to allow the bait to float horizontally). In a specific example for catfish, the cage need not be clear, and at least one eyehook for the line placed below the lid hinge.

According to one example of the invention, there is provided a method for sustaining bait during fishing operations, comprising the steps of: enclosing the bait in a capsulate shaped structure having a means for entry and egress of the bait, wherein the interior of the capsulate shaped structure is in fluid communication with the exterior of the capsulate shaped structure; inserting the bait into the capsulate shaped structure through the entry means; deactivating the entry means, wherein the deactivation step further comprises means for reactivating, the entry reactivation means comprising the step of: applying pressure to radial diametrically opposed sides of the exterior of the capsulate shaped structure at a similar longitudinal position along the capsulate shaped structure, the pressure maintained relative to a perpendicular direction from the radial diametrically opposed sides, whereby the length of at least one dimension of the entry means of the capsulate shaped structure is modified; affixing a line to the capsulate shaped structure, the capsulate shaped structure having at least one anchor point for affixing the line; and affixing a hook to the capsulate shaped structure, the capsulate shaped structure having at least one anchor point for affixing the hook.

According to one example of the invention, there is provided a system for sustaining bait during fishing operations, comprising: means for enclosing the bait, wherein fluid communication between the exterior and exterior of the enclosure means is maintained; means for entry and egress of the bait into or out of the enclosure means, the entry means disposed on the enclosure means; means for deactivating the entry means, the entry deactivation means disposed on the enclosure means; means for reactivating the entry means, wherein the reactivation means comprises means for making modifiable at least one dimension of the entry means by applying pressure to radial diametrically opposed sides of the exterior of the enclosure means at a similar longitudinal position along the enclosure means, the pressure maintained relative to a perpendicular direction from the radial diametrically opposed sides; at least one means for affixing a line to the enclosure means, the enclosure means having at least one anchor point for affixing the line; and at least one means for affixing a hook to the enclosure means, the enclosure means having at least one anchor point for affixing the hook.

According to one set of examples of the invention, there is provided a device for sustaining bait during fishing operations, comprising: a capsulate shaped structure having an opening for inserting the bait; a lid hingedly disposed on the capsulate shaped structure, whereby the opening may be covered; at least one first anchor point operable to receive a line, the at least one first anchor point disposed on the capsulate shaped structure; at least one second anchor point operable to receive a hook, the at least one second anchor point disposed on the capsulate shaped structure; wherein the lid further comprises a clasp, the clasp releasably mated with the capsulate shaped structure when the lid is positioned so as to cover the opening; wherein the mating of the clasp of the lid with the capsulate shaped structure releases upon application of pressure to radial diametrically opposed sides of the exterior of the capsulate shaped structure at a similar longitudinal position along the capsulate shaped structure in proximity to the clasp of the hinge, the pressure maintained relative to a perpendicular direction from the radial diametrically opposed sides, whereby the length of at least one dimension of the entry means of the capsulate shaped structure is modified; and wherein the capsulate shaped structure further comprises at least one vent whereby the interior of the capsulate shaped structure is in fluid communication with the exterior of the capsulate shaped structure.

In another example, the at least one first anchor point and the at least one second anchor point further comprise key rings attached to the first and the second anchor points, whereby the anchor points are protected from damage and change-out of hooks is made easier.

In another example, the hingedly disposed lid further comprises a stainless steel hinge, whereby corrosion is avoided.

In another example, the at least one of the at least one first anchor point is disposed radially opposite to at least one of the at least one second anchor point, whereby the device floats approximately horizontal with respect to any hooks attached to the at least one second anchor point.

In another example, the capsulate shaped structure is substantially transparent, whereby the device may be used for sight feeding fish.

In another example, the device further comprises premeasured front and rear means for buoyancy, the buoyancy means disposed in the capsulate shaped structure, whereby the device may be used in top water fishing.

In another example, at least one of the at least one first anchor point is disposed in a nose portion of the capsulate shaped structure, whereby the device is pulled straight and may be used for casting.

In another example, at least one second anchor point comprises at least three anchor points arranged on a radial diametrically opposed side from the at least one first anchor point.

In another example, at least one of the at least one first anchor point is disposed in a mid longitudinal portion of the capsulate shaped structure, whereby the device may be used for crappie fishing and may be used for up-down motion.

In another example, at least one second anchor point comprises at least three anchor points arranged on a radial diametrically opposed side from the at least one first anchor point.

In another example, the capsulate shaped structure has a size ratio of approximately 1:2, radial to longitudinal dimension.

In another example, the at least one of the at least one second anchor point is disposed below the hinge of the hingedly disposed lid, whereby the device may be used for catfish fishing.

In another example, the at least one of the at least one first anchor point is disposed radially opposite of the at least one second anchor point, whereby the device enables minnow bait to float horizontally.

In another example, the capsulate shaped structure has a size of approximately 1″ radial dimension and 2″ longitudinal dimension, whereby the device may be used for catfish fishing.

In another example, the capsulate shaped structure has a size of approximately between 1″ to 5″ radial dimension and approximately between 2″ to 9″ longitudinal dimension, with a size ratio of between approximately 1:2 and 5:9, radial to longitudinal dimension, whereby the device may be used for catfish fishing.

In another example, the capsulate shaped structure has a size of approximately ¾″ radial dimension and 3″ longitudinal dimension, whereby the device may be used for crappie fishing.

In another example, the capsulate shaped structure has a size of approximately between ½″ to 1″ radial dimension and approximately between 2″ to 6″ longitudinal dimension, with a size ratio of between approximately 1:4 and 1:6, radial to longitudinal dimension, whereby the device may be used for crappie fishing.

### BRIEF DESCRIPTION OF THE DRAWINGS

FIG. 1 shows a 3-D perspective view of an example of the present invention.

FIG. 2 shows a perspective side view of an example of the present invention, showing hingedly disposed lid, anchor points, and vents.

FIG. 3 shows a perspective side view of another example of the present invention, showing hingedly disposed lid, anchor points, and vents.

### DETAILED DESCRIPTION OF THE INVENTION

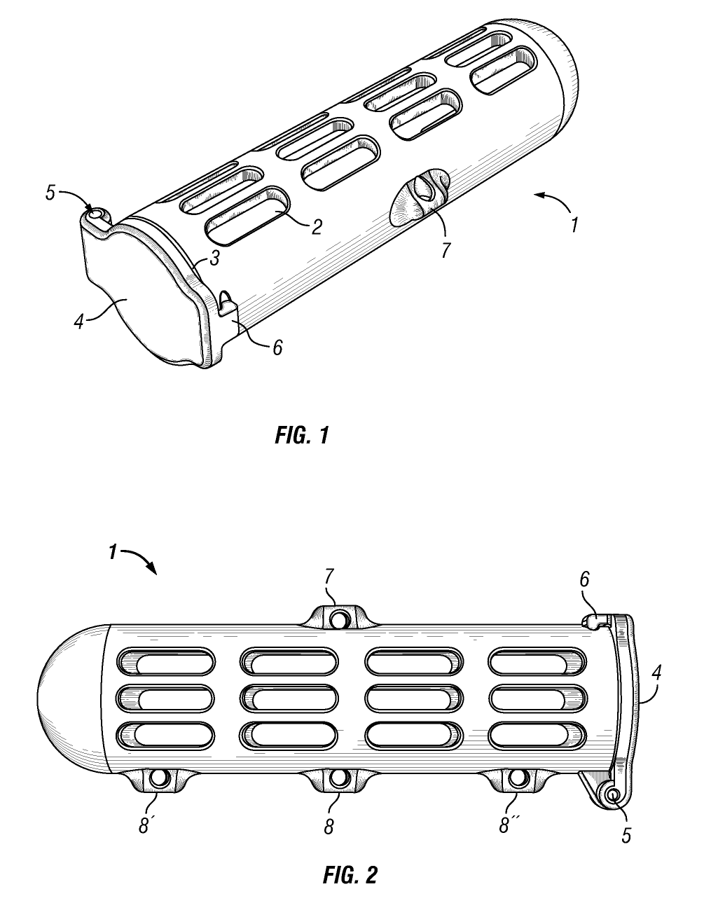

Various aspects of the invention, including alternative embodiments and the various functionalities associated therewith, are disclosed with particularity in the attached drawings, FIGS. 1 through 3. Applicant submits that those of ordinary skill in the art will recognize and be able to appreciate the advantages of the device and methods.

FIG. 1 illustrates an example of the present invention, a system or device for sustaining bait during fishing operations. A capsulate shaped structure 1 illustrates one example of means for enclosing the bait. Capsulate shaped structure 1 is typically made from a semi-rigid molded plastic, but can be made from any material that provides the properties described. In at least one example, the capsulate shaped structure is substantially transparent, whereby the device may be used for sight feeding fish. Capsulate shaped structure 1 typically has a radial dimension and a longitudinal dimension. In at least one example, the capsulate shaped structure has a size ratio of approximately 1:2, radial to longitudinal dimension. In another example, the capsulate shaped structure has a size of approximately 1″ radial dimension and 2″ longitudinal dimension, whereby the device may be used for catfish fishing. In another example, the capsulate shaped structure has a size of approximately between 1″ to 5″ radial dimension and approximately between 2″ to 9″ longitudinal dimension, with a size ratio of between approximately 1:2 and 5:9, radial to longitudinal dimension, whereby the device may be used for catfish fishing or larger fish. In another example, the capsulate shaped structure has a size of approximately ¾″ radial dimension and 3″ longitudinal dimension, whereby the device may be used for crappie fishing. In another example, the capsulate shaped structure has a size of approximately between ½″ to 1″ radial dimension and approximately between 2″ to 6″ longitudinal dimension, with a size ratio of between approximately 1:4 and 1:6, radial to longitudinal dimension, whereby the device may be used for crappie fishing.

One or more vents 2 are disposed on capsulate shaped structure 1, providing fluid communication between the exterior and exterior of the enclosure. Vents 2 allow any enclosed bait to breath. The vents further allow the smell and vibrations of the bait enclosed therein to emanate into the surroundings about the enclosure means. Vents 2 are typically small in relation to the desired bait, so that the bait may not escape the enclosure means.

An opening 3 disposed on capsulate shaped structure 1 provides an opening means for entry and egress of the bait into or out of the enclosure means. Opening 3 is typically large enough in relation to the desired bait, so that the bait may be inserted or removed from the capsulate shaped structure or other configured enclosure means.

A lid 4 provides means for deactivating the entry means, the deactivation means disposed on the enclosure means. In one example, lid 4 is hingedly disposed on capsulate shaped structure 1, whereby opening 3 may be covered. In one example, hingedly disposed lid 4 further comprises a stainless steel hinge 5, whereby corrosion is avoided.

Lid 4 further comprises a clasp 6 disposed on an edge of lid 4 and mated with an indentation on capsulate shaped structure 1. Clasp 6 is releasably mated with capsulate shaped structure 1 when lid 4 is positioned so as to cover opening 3. A means for reactivating the entry means, opening lid 4 to uncover opening 3, is provided by the semi-rigid property of capsulate shaped structure 1. The reactivation means comprises means for making modifiable at least one dimension of the entry means by applying pressure to radial diametrically opposed sides of the exterior of the enclosure means. Such pressure is typically applied at a similar longitudinal position along the enclosure means, such as in proximity to clasp 6 of the hinged lid 4, the pressure maintained relative to a perpendicular direction from the radial diametrically opposed sides. Application of such pressure causes the mating of clasp 6 of lid 4 with capsulate shaped structure 1 to release, owing to change in length of at least one dimension of the entry means of capsulate shaped structure 1. A fish generally cannot exert such pressure to radial diametrically opposed sides of the exterior of the enclosure means and, therefore, is unlikely to reactivate lid 4. A user, however, typically enjoys the ability to hold capsulate shaped structure 1 and reactive lid 4 using only one hand, simply by pressing the thumb and index finger against the end of capsulate shaped structure 1 while embracing the rest of structure 1 with the remaining fingers and palm of the hand.

At least one first anchor point 7 is disposed on capsulate shaped structure 1, providing at least one means for affixing a line to the enclosure means. First anchor point 7 is operable to receive a line. In at least one example, at least one first anchor point 7′ (illustrated in FIG. 3) is disposed in a nose portion of capsulate shaped structure 1, whereby the device is pulled straight and may be used for casting. In another example, at least one first anchor point 7 is disposed in a mid longitudinal portion of capsulate shaped structure 1, whereby the device may be used for crappie fishing and may be used for up-down motion.

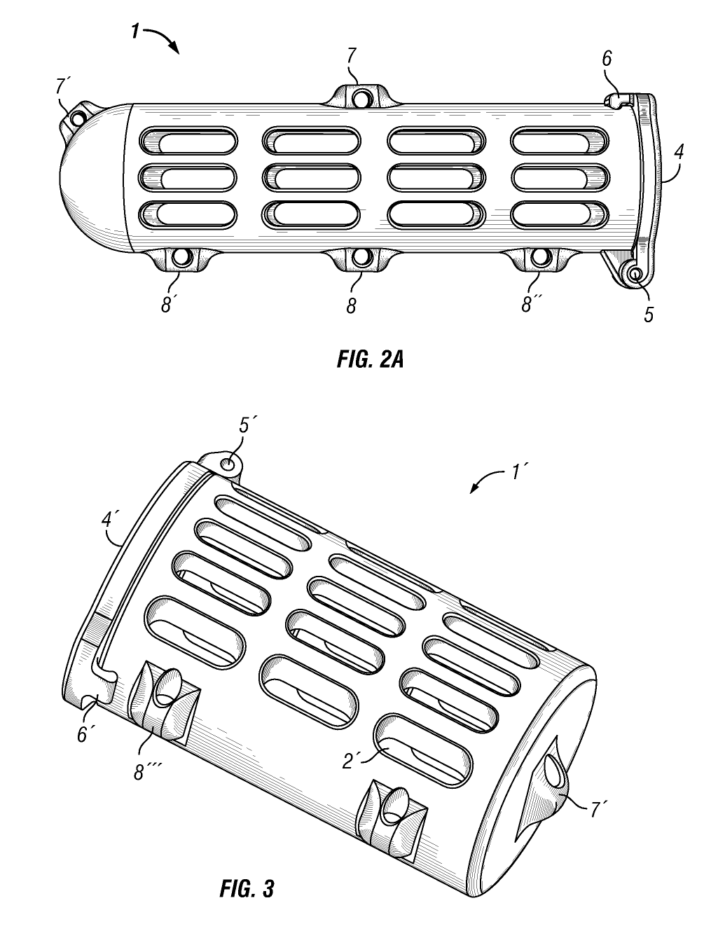

As illustrated in FIG. 2, at least one second anchor point 8 is disposed on capsulate shaped structure 1, providing at least one means for affixing a hook to capsulate shaped structure 1. Second anchor point 8 is operable to receive a hook. In at least one example, at least one second anchor point 8 is disposed on capsulate shaped structure 1 below the hinge of hingedly disposed lid 4, whereby the device may be used for catfish fishing. In another example, at least one first anchor point 7 is disposed radially opposite to at least one second anchor point 8, whereby the device floats approximately horizontal with respect to any hooks attached to the at least one second anchor point 8. In another example, at least one second anchor point 8 comprises at least three anchor points (8, 8′, 8″) arranged on a radial diametrically opposed side from at least one first anchor point 7. The device enables minnow bait to float horizontally.

In another example, at least one first anchor point 7 and at least one second anchor point 8 further comprise key rings (not illustrated) attached to first and the second anchor points (7, 8), whereby anchor points (7, 8) are protected from damage and change-out of hooks is made easier.

In another example, the device further comprises premeasured front and rear means for buoyancy, the buoyancy means disposed in the capsulate shaped structure, whereby the device may be used in top water fishing. In an example, small buoyant tablets (not illustrated) are inserted in the nose of capsulate shaped structure 1 and inside of lid 4. In a further example, buoyant tablets are made of a water resistant plastic foam.

FIG. 2A illustrates another example of the present invention. At least one first anchor point 7′ is disposed in a nose portion of capsulate shaped structure 1, whereby the device is pulled straight and may be used for casting. Where the nose is of rounded shape, placement of anchor point 7′ at forty-five (45) degrees along the curve of the nose, as shown in FIG. 2A, exhibits beneficial results.

FIG. 3 illustrates another example of the present invention. Capsulate shaped structure 1′ encloses a volume approximately one inch (1″) in diameter and approximately two inches (2″) long. The outside dimensions are approximately one and one-quarter inch diameter (1.25″) and two and one-quarter inch long (2.25″), including a lid portion, which will be described shortly. One or more vents 2′ are disposed on capsulate shaped structure 1′, providing fluid communication between the exterior and exterior of the enclosure. Vents 2′ are approximately one-eighth inch (⅛″) wide by approximately three-eighths inch (⅜″) long. Lid 4′ is hingedly disposed on capsulate shaped structure 1′, whereby an opening may be covered. Lid 4′ further comprises a stainless steel hinge 5′, whereby corrosion is avoided. Lid 4′ further comprises a clasp 6′ disposed on an edge of lid 4′ and mated with an indentation on capsulate shaped structure 1′. At least one first anchor point 7′ is disposed on capsulate shaped structure 1′. First anchor point 7′ is operable to receive a line. In this example, at least one first anchor point 7′ is disposed in a nose portion of capsulate shaped structure 1′, whereby the device is pulled straight and may be used for casting. At least one second anchor point 8′″ is disposed on capsulate shaped structure 1′. Second anchor point 8′″ is operable to receive a hook. In this example, at least one second anchor point 8′″ disposed on capsulate shaped structure 1′ below the hinge of hingedly disposed lid 4′, whereby the device may be used for catfish fishing. Anchor point holes are approximately three-sixteenths inch ( 3/16″) diameter.

In practice, the bait is enclosed in the capsulate shaped structure of the bait cage. The bait cage has a means for depositing or removing the bait in the bait cage, such as a closable opening or other entry means. Vents on the body of the bait cage allow the interior of the bait cage to be in fluid communication with the exterior of the bait cage. The bait is inserted into the bait cage through the closable opening or entry means. The closable opening is then closed, or the entry means otherwise deactivated. This closable opening may be reopened; that is, the deactivation step has means for reactivating. The closable opening may be reopened by applying pressure to the body of the bait cage on opposite sides of the bait cage and near the opening. Opposite sides of the bait cage may be more precisely termed to be at radial diametrically opposed sides of the exterior of the bait cage, which are at a similar longitudinal position along the bait cage. By applying pressure on opposite sides of the bait cage, the bait cage will be squeezed such that it will slightly expand in the direction perpendicular to the squeeze. In other words, the pressure is maintained relative to a perpendicular direction from the radial diametrically opposed sides, whereby the length of at least one dimension of the entry means of the capsulate shaped structure is modified. A line is affixed to the bait cage, the bait cage having at least one anchor point for affixing the line. A hook is affixed to the bait cage, the bait cage having at least one anchor point for affixing the hook. The bait cage is now prepared for use in fishing operations.

The foregoing description is presented for purposes of illustration and description, and is not intended to limit the invention to the forms disclosed herein. Consequently, variations and modifications commensurate with the above teachings and the teaching of the relevant art are within the spirit of the invention. Such variations will readily suggest themselves to those skilled in the relevant structural or mechanical art. Where approximations are disclosed to describe a numerical value, it is suggested that the precision of the disclosed preferred numerical value is based on the number of significant digits given and that it is further suggested that deviations from the disclosed numerical value that is within the disclosed precision would be a matter of engineering choice and/or within the realm of simple experimentation. Again, such variations will readily suggest themselves to those skilled in the relevant structural or mechanical art. Further, the embodiments described are also intended to explain the best mode for carrying out the invention, and to enable others skilled in the art to utilize the invention and such or other embodiments and with various modifications required by the particular applications or uses of the invention. It is intended that the appended claims be construed to include alternative embodiments to the extent that is permitted by prior art.

I claim:

1. A method for sustaining bait during fishing operations, comprising the steps of:
enclosing the bait in a capsulate shaped structure having a means for entry and egress of the bait, wherein said interior of said capsulate shaped structure is in fluid communication with the exterior of said capsulate shaped structure;
inserting the bait into said capsulate shaped structure through said entry means;
deactivating said entry means, wherein in said deactivation step further comprises means for reactivating, said entry reactivation means comprising the step of:
applying pressure to radial diametrically opposed sides of the exterior of said capsulate shaped structure at a similar longitudinal position along said capsulate shaped structure, said pressure maintained relative to a perpendicular direction from said radial diametrically opposed sides, whereby the length of at least one dimension of said entry means of said capsulate shaped structure is modified;
affixing a line to said capsulate shaped structure, said capsulate shaped structure having at least one anchor point for affixing the line; and
affixing a hook to said capsulate shaped structure, said capsulate shaped structure having at least one anchor point for affixing the hook.

2. A system for sustaining bait during fishing operations, comprising:
means for enclosing the bait, wherein fluid communication between the exterior and exterior of said enclosure means is maintained;
means for entry and egress of the bait into or out of said enclosure means, the entry means disposed on said enclosure means;
means for deactivating said entry means, the entry deactivation means disposed on said enclosure means;
means for reactivating said entry means, wherein said reactivation means comprises means for making modifiable at least one dimension of said entry means by applying pressure to radial diametrically opposed sides of the exterior of said enclosure means at a similar longitudinal position along said enclosure means, said pressure maintained relative to a perpendicular direction from said radial diametrically opposed sides;
at least one means for affixing a line to said enclosure means, said enclosure means having at least one anchor point for affixing the line; and
at least one means for affixing a hook to said enclosure means, said enclosure means having at least one anchor point for affixing the hook.

3. A device for sustaining bait during fishing operations, comprising:
a capsulate shaped structure having an opening for inserting the bait;
a lid hingedly disposed on said capsulate shaped structure, whereby said opening may be covered;
at least one first anchor point operable to receive a line, said at least one first anchor point disposed on said capsulate shaped structure;
at least one second anchor point operable to receive a hook, said at least one second anchor point disposed on said capsulate shaped structure;
wherein said lid further comprises a clasp, said clasp releasably mated with said capsulate shaped structure when said lid is positioned so as to cover said opening;
wherein the mating of said clasp of said lid with said capsulate shaped structure releases upon application of pressure to radial diametrically opposed sides of the exterior of said capsulate shaped structure at a similar longitudinal position along said capsulate shaped structure in proximity to said clasp of said hinge, said pressure maintained relative to a perpendicular direction from said radial diametrically opposed sides, whereby the length of at least one dimension of said entry means of said capsulate shaped structure is modified; and
wherein said capsulate shaped structure further comprises at least one vent whereby the interior of said capsulate shaped structure is in fluid communication with the exterior of said capsulate shaped structure.

4. The device of claim 3 wherein said at least one first anchor point and said at least one second anchor point further comprise key rings attached to said first and said second anchor points, whereby said anchor points are protected from damage and changeout of hooks is made easier.

5. The device of claim 3 wherein said hingedly disposed lid further comprises a stainless steel hinge, whereby corrosion is avoided.

6. The device of claim 3 wherein at least one of said at least one first anchor point is disposed radially opposite to at least one of said at least one second anchor point, whereby said device floats approximately horizontal with respect to any hooks attached to said at least one second anchor point.

7. The device of claim 3 wherein said capsulate shaped structure is substantially transparent, whereby said device may be used for sight feeding fish.

8. The device of claim 3 further comprising premeasured front and rear means for buoyancy, said buoyancy means disposed in said capsulate shaped structure, whereby said device may be used in top water fishing.

9. The device of claim 3 wherein at least one of said at least one first anchor point is disposed in a nose portion of said capsulate shaped structure, whereby said device is pulled straight and may be used for casting.

10. The device of claim 9 wherein at least one second anchor point comprises at least three anchor points arranged on a radial diametrically opposed side from said at least one first anchor point.

11. The device of claim 3 wherein at least one of said at least one first anchor point is disposed in a mid longitudinal portion of said capsulate shaped structure, whereby said device may be used for crappie fishing and may be used for up-down motion.

12. The device of claim 11 wherein at least one second anchor point comprises at least three anchor points arranged on a radial diametrically opposed side from said at least one first anchor point.

13. The device of claim 3 wherein said capsulate shaped structure has a size ratio of approximately 1:2, radial to longitudinal dimension.

14. The device of claim 3 wherein said at least one of said at least one second anchor point is disposed below the hinge of said hingedly disposed lid, whereby said device may be used for catfish fishing.

15. The device of claim 3 wherein said at least one of said at least one first anchor point is disposed radially opposite of said at least one second anchor point, whereby said device enables minnow bait to float horizontally.

16. The device of claim 3 wherein said capsulate shaped structure has a size of approximately 1″ radial dimension and 2″ longitudinal dimension, whereby said device may be used for catfish fishing.

17. The device of claim 3 wherein said capsulate shaped structure has a size of approximately between 1″ to 5″ radial dimension and approximately between 2″ to 9″ longitudinal dimension, with a size ratio of between approximately 1:2 and 5:9, radial to longitudinal dimension, whereby said device may be used for catfish fishing.

18. The device of claim 3 wherein said capsulate shaped structure has a size of approximately ¾″ radial dimension and 3″ longitudinal dimension, whereby said device may be used for crappie fishing.

19. The device of claim 3 wherein said capsulate shaped structure has a size of approximately between ½″ to 1″ radial dimension and approximately between 2″ to 6″ longitudinal dimension, with a size ratio of between approximately 1:4 and 1:6, radial to longitudinal dimension, whereby said device may be used for crappie fishing.
